(19) United States
(12) Patent Application Publication
(10) Pub. No.: US 2025/0325946 A1
(43) Pub. Date: Oct. 23, 2025

(54) DEVICE FOR RAPID CARBONATION OF BEVERAGES

(71) Applicant: Iowa State University Research Foundation, Inc., Ames, IA (US)

(72) Inventors: Robert C. Brown, Ames, IA (US); Alexandra B. Jean, Ames, IA (US); Jordan Funkhouser, Ames, IA (US)

(21) Appl. No.: 19/184,904

(22) Filed: Apr. 21, 2025

Related U.S. Application Data
(60) Provisional application No. 63/637,130, filed on Apr. 22, 2024.
(60) Provisional application No. 63/707,443, filed on Oct. 15, 2024.

(51) Int. Cl. B01F 23/237; A23L 2/54; B01F 23/213; B01F 23/236; B01F 35/90; B01F 101/14; B01F 101/15; B01F 101/17; C12C 11/11

(52) U.S. Cl. CPC B01F 23/237621; A23L 2/54; B01F 23/2132; B01F 23/2362; B01F 35/90; C12C 11/11; B01F 2035/98; B01F 2101/14; B01F 2101/15; B01F 2101/17

(57) ABSTRACT

Carbonation is the process of dissolving carbon dioxide into beverages like beer, sparkling wine, and seltzer water. To speed up the carbonation process, a still liquid is atomized into droplets as it is added to a container pressurized with carbon dioxide. The gas in the container will adsorb into the droplets more quickly than for traditional carbonation methods because of the large surface area-to-volume ratio of the droplets. The carbonated droplets will collect as pooled liquid in the bottom of the container from which it is sent to a storage vessel carbonated to the desired level. The system and process allows for carbonation of liquid at a rate of several gallons per minute, which is a significant increase over current processes.

### CROSS REFERENCE TO RELATED APPLICATIONS

This application claims priority under 35 U.S.C. § 119 (e) to provisional patent applications U.S. Ser. No. 63/637,130, filed Apr. 22, 2024, and U.S. Ser. No. 63/707,443, filed Oct. 15, 2024.

The provisional patent applications are hereby incorporated by reference in their entirety herein, including without limitation: the specification, claims, and abstract, as well as any figures, tables, appendices, or drawings thereof.

### TECHNICAL FIELD

The present disclosure relates generally to systems, methods, and/or apparatus for the carbonation of beverages. More particularly, but not exclusively, the disclosure includes methods, systems, and/or apparatus that accelerates the rate of carbonation of beverages.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Carbonation is the process of dissolving carbon dioxide (CO₂) into beverages like beer, sparkling wine, and seltzer water. Beverages are typically carbonated through forced carbonation methods involving injection of carbon dioxide bubbles into the liquid product in a designated carbonation vessel or in-line as the beverage is transferred from the fermentation vessel. The bubbles gradually dissolve into the liquid to carbonate the beverage, and the rate of carbonation is governed by the size of the bubbles, the temperature of the liquid, and the operating pressure of the carbonation vessel. Although small bubbles dissolve more effectively in the beverage, sufficient carbonation of the entire liquid product can take several days. Moreover, small bubbles may interact and coalesce as they travel through the liquid, making it difficult to achieve small, uniformly dispersed bubbles.

The process is traditionally accomplished by exposing an uncarbonated beverage to an atmosphere of carbon dioxide in the head space of a vessel containing the beverage or bubbling carbon dioxide into the liquid through a porous “carbonation stone.” The time to carbonate beverages to the desired volumes of dissolved gas depends upon the gas pressure and size of bubbles emitted from carbonation stones.

Carbonation in vessels, referred to as bright tanks in the brewing industry, can take up to two days to reach the desired volume of carbon dioxide in the beverage. The length of time slows down many other processes, such as canning or bottling, as well as the ability to move from one product to the next. The only current way to speed up the process or to be able to carbonate more beverages is to add more vessels, which increases costs and needed space.

Thus, there exists a need in the art for systems, methods, and/or apparatus that increase the rate of carbonation of liquids, which decreases the amount of time in the process for carbonating beverages.

In addition, there is an issue in carbonization, especially as it relates to the carbonation beer, with the potential for the loss of hop aromas. This is unwanted, as it could affect the taste and smell of beer being brewed.

Therefore, there is another need to mitigate the loss of hop aroma of a beverage, such as beer, during the carbonization process.

Still further, while the carbonization process is generally utilized with larger volumes of liquids, this can be problematic. For example, during the preparation of beverages, different flavors, flavor profiles, and other inputs are added to get desired taste and smell results. Traditionally, you would need to wait until the full, large volume product has been mixed and potentially carbonated to test (i.e., taste and/or smell) to determine if the results are as intended. If not, the batch may be wasted.

Therefore, there is yet another need to incorporate systems and methods into smaller scale testing systems to provide quick results that can be tested in light of the inputs for the beverage.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects of any of the embodiments of the present disclosure to increase the carbonation rate of liquids, such as beverages. For example, aspects of the disclosure provide systems, methods, and/or apparatus that can carbonate beverages at the rate of several gallons per minute, depending upon the design and operation of the carbonation vessel, which is at least an order of magnitude faster than traditional methods.

It is still yet a further object, feature, and/or advantage of any of the aspects of any of the embodiments of the present disclosure to be able to be used with systems of various sizes, such as batch system or continuous flow systems.

It is yet another object, feature, and/or advantage of any of the aspects of any of the embodiments of the present disclosure to be able to carbonate beverages in a chilled environment. The chilled liquid can be filtered prior to carbonization of the liquid or can be carbonated at a higher temperature.

It is still another object, feature, and/or advantage of any of the aspects of any of the embodiments of the present disclosure to increase the surface area-to-volume ratio at the liquid-gas (CO₂) interface. Although small bubbles can dissolve effectively in traditional bubble systems, the surface area of the liquid exposed to the gas bubble interface is relatively small compared to the volume of the liquid to be carbonated, and the time to reach a desired level of carbonation (measured as volumes of gas per volume of liquid at standard temperature and pressure) in the bulk liquid is large. The approach increases the liquid interface over which mass transfer occurs, effectively increasing the surface area-to-volume ratio of the liquid to be saturated.

It is still another object, feature, and/or advantage of any of the aspects of any of the embodiments of the present disclosure to reduce the size of equipment needed and increase the rate of beverage carbonation.

It is yet another object, feature, and/or advantage of aspects of the present disclosure to operate at a pressure wherein hop aroma losses are low.

It is still yet another object, feature, and/or advantage of aspects of the present disclosure to provide a small scale version of any of the systems and/or methods provided to allow for quick and accurate feedback.

The systems, methods, and/or apparatus disclosed herein can be used in a wide variety of applications. For example, as noted, the disclosure can be used for the carbonation of any beverage and can be set up for different levels of scale.

It is preferred that the systems and/or apparatus disclosed be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the system or apparatus.

Methods can be practiced which facilitate use, manufacture, assembly, maintenance, and repair of a system/apparatus, which accomplish some or all of the previously stated objectives. The methods can include methods of operation, processes, or even methods of manufacture.

According to some aspects of the present disclosure, a system for carbonating a liquid comprises a liquid supply; a carbonation vessel fluidly connected to the liquid supply to receive liquid therefrom, the carbonation vessel comprising a nozzle at an inlet, wherein the liquid passes through the nozzle to form droplets; and a collection vessel fluidly connected to the carbonation vessel to receive the liquid from the carbonation vessel; wherein the carbonation vessel is pressurized with carbon dioxide so the droplets pass through the carbon dioxide before collecting and moving to the collection vessel.

According to at least some aspects of some embodiments, the system further comprises a pressure drop coil between the carbonation vessel and the collection vessel and wherein the carbonated liquid from the carbonation vessel is passed through the pressure drop coil.

According to at least some aspects of some embodiments, the system further comprises a carbon dioxide source fluidly connected to carbonation vessel.

According to at least some aspects of some embodiments, the system further comprises a pump to move the liquid from the liquid supply to the carbonation vessel.

According to at least some aspects of some embodiments, the system further comprises a filter inline between the liquid supply and the carbonation vessel.

According to at least some aspects of some embodiments, the system further comprises a heat exchange between the liquid supply and the carbonation vessel to cool the liquid before it is carbonated.

According to at least some aspects of some embodiments, the liquid is divided before the carbonation vessel with a first portion of liquid passed through the nozzle for carbonating in the carbonation vessel and the second portion bypasses the carbonation vessel, and wherein the first and second portions are combined in a mixer before passing into the collection vessel.

According to at least some aspects of some embodiments, carbon dioxide is used to push the liquid towards the carbonation vessel.

According to at least some aspects of some embodiments, the collection vessel includes a spunding valve.

According to at least some aspects of some embodiments, the pressure of the carbonation vessel is selected based upon beverage type to retain a desired aroma profile.

According to at least some aspects of some embodiments, the desired aroma profile comprises a hop aroma.

According to at least some aspects of some embodiments, the liquid supply supplies 0.5-gallons of liquid to the system.

According to additional aspects of the disclosure, a method of carbonating a still liquid comprises pressurizing a carbonation vessel with carbon dioxide; adding still liquid into the carbonation vessel via a nozzle inlet, wherein the nozzle inlet breaks up the still liquid into small droplets that pass through the pressurized carbonation vessel; collecting the carbonated droplets as a carbonated liquid; and moving the carbonated liquid through a pressure drop coil and into a collection vessel.

According to at least some aspects of some embodiments, the method further comprises pressurizing the collection vessel before the carbonated liquid is added thereto.

According to at least some aspects of some embodiments, the pressure of the collection vessel is selected based upon beverage type to retain a desired aroma profile.

According to at least some aspects of some embodiments, the desired aroma profile comprises a hop aroma.

According to at least some aspects of some embodiments, the method further comprises filtering the still liquid before carbonation vessel.

According to at least some aspects of some embodiments, the method further comprises cooling the still liquid after filtration.

According to at least some aspects of some embodiments, the method further comprises splitting the still liquid into a first path that directs the liquid into the carbonation vessel via the nozzle inlet, and a second path that bypasses the carbonation vessel.

According to at least some aspects of some embodiments, the method further comprises combining the liquids from the first and second paths before moving the carbonated liquid into the collection vessel.

According to at least some aspects of some embodiments, the method further comprises mixing the liquids of the first and second paths via an inline static mixer.

According to at least some aspects of some embodiments, the still liquid is an amount 0.5-gallons or less.

According to at least some aspects of some embodiments, the method further comprises cooling the carbonated liquid before moving the carbonated liquid through the pressure drop, and wherein the collection vessel is used for taste testing.

According to additional aspects of the disclosure, a system for carbonating a still liquid comprises a liquid supply; a carbonation vessel fluidly connected to the liquid supply to receive still liquid therefrom, the carbonation vessel comprising an atomizer at an inlet for the still liquid, wherein the carbonization vessel carbonates the atomized liquid; and a collection vessel fluidly connected to the carbonation vessel to receive the carbonated liquid from the carbonation vessel.

According to at least some aspects of some embodiments, the carbonation vessel is pressurized with carbon dioxide so the atomized still liquid passes through the carbon dioxide before collecting and moving to the collection vessel.

According to at least some aspects of some embodiments, the system further comprises a pressure drop coil between the carbonation vessel and the collection vessel and wherein the carbonated liquid from the carbonation vessel is passed through the pressure drop coil.

According to at least some aspects of some embodiments, the atomizer comprises a nozzle.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic of a batch system for carbonating a still liquid and including aspects of the present disclosure.

FIG. 2 is a schematic of a continuous-flow system for carbonating a still liquid and including aspects of the present disclosure.

FIG. 3 is a schematic of another continuous-flow system for carbonating a still liquid and including aspects of the present disclosure.

FIG. 4 is a schematic of a manifold system for use with any of the carbonation systems for use in filling multiple vessels.

FIG. 5 is a schematic of an automation system for controlling one or more aspects of the carbonation systems disclosed.

FIG. 6 is a graph showing the relationship between carbonation tank pressure and fraction of hop aroma retained for ales.

FIG. 7 is a graph showing the relationship between carbonation tank pressure and fraction of hop aroma retained for lagers.

FIG. 8 is a schematic of a miniaturized system for carbonating a small amount of liquid in short time.

FIG. 9 is a group of tables with proposed settings for the system shown in the schematic of FIG. 8.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

As will be understood, aspects and/or embodiments of the present disclosure refer to carbonation of liquids. It should be noted that the systems, methods, and/or apparatus as disclosed or inferred herein can be used to carbonate any liquid, such as any still, flat, uncarbonated, or even partially carbonated liquid, such as to carbonate the liquid to a desired level. Some non-limiting examples of such liquids can be beverages, such as water, cola, soda, beer, sparkling wine, seltzer, juice, hard ciders, kombucha, teas, coffee, or any variation, combination, or derivative thereof. As stated herein, traditional methods and systems for carbonating liquids are cumbersome and/or take a relatively long time (e.g., multiple days) for the liquids to achieve desired carbonation levels (i.e., desired levels of carbon dioxide, also referred to herein as CO2, in the liquid).

Referring to the figures, various aspects and/or embodiments include systems (for example systems 10, 40, and 70 in the figures) that provide for an accelerated rate that carbon dioxide is dissolved in water or other liquids by breaking up the liquid into small droplets in a pressurized atmosphere of carbon dioxide gas. As the droplets are made smaller, their surface area-to-volume ratio increases. Since the rate of gas adsorption into a liquid is directly proportional to the surface area of the liquid, the production of small liquid droplets will enhance the rate of gas adsorption.

This is in contrast to generating gas bubbles in a bulk liquid, as is conventionally employed to carbonate beverages. Generating sufficiently small gas bubbles to achieve high interfacial surface area between gas and liquid is more difficult than generating small liquid droplets in bulk gas. Moreover, gas bubbles may interact as they travel throughout the liquid, making it difficult to achieve small, uniformly dispersed gas substrate in the liquid.

The liquid droplets are produced by passing the liquid under pressure through a nozzle or multiple nozzles where shear forces break up the liquid into individual droplets. In other words, the nozzle(s) atomize the liquid as it is directed into a pressurized container or vessel. The size of the droplets leaving a nozzle as well as the liquid flow rate through the nozzle are a function of the differential pressure between the liquid entering the nozzle and the pressure in the vessel receiving the spray. It is preferred that the atomized liquid falls through the vessel as droplets rather than impacting on and running down the walls of the carbonation vessel as a film layer, which would reduce the effective surface area-to-volume ratio of the liquid. The amount of gas that can be absorbed, which is the condition of gas saturation, is a function of temperature of the liquid and gas pressure imposed upon it. If the droplets are given sufficient time to absorb carbon dioxide, the liquid will eventually reach saturation and no further absorption will occur. The time it takes to approach saturation is a function of both the size of droplets and their residence time in the pressurized gas atmosphere. When the combination of droplet size and residence time are insufficient to reach the desired level of carbonation (that is a specified volumes of gas per volume of liquid at standard temperature and pressure), the pressure may be increased to provide more driving force to the mass transfer, allowing the droplets to reach a higher degree of carbonation in a shorter period of time.

The rate that liquid can be carbonated to a desired level is a function of the hold-up of liquid in the carbonation vessel/container; that is, the percent of the vessel volume that is filled with liquid droplets falling through it. The liquid hold-up can be increased by increasing the number of nozzles installed in the top of the carbonation vessel, because the flow rate of liquid for a single nozzle is limited by the pressure differential across the nozzle and the geometry of the nozzle. Once the liquid reaches the bottom of the carbonation vessel, the pool of liquid is pumped or otherwise directed into a storage vessel at the desired carbonation level.

Furthermore, while the term nozzle has been used, it should be noted that any droplet generator (e.g., nozzle, spray manifold, dripper, etc.) or other liquid atomizer could be used.

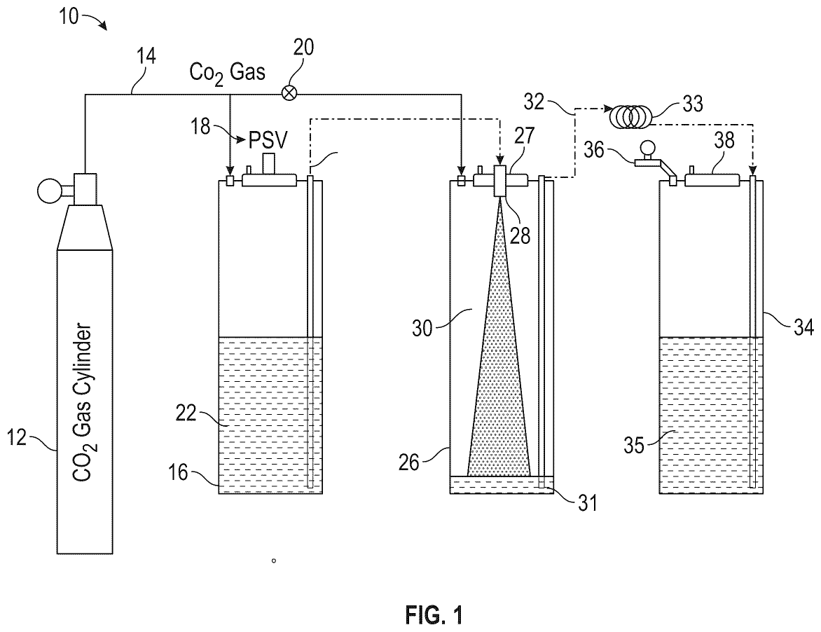

As will be appreciated, there are several systems and/or methods for carbonating liquids through production of liquid sprays in an atmosphere of carbon dioxide. FIG. 1 illustrates a batch-style manifestation of the present disclosure. The system 10 includes three gas-tight vessels, referred to as kegs: (1) the supply keg 16 containing chilled, uncarbonated (still) liquid 22; (2) the carbonation keg 26; and (3) the storage keg 34. The carbonation keg 26 is equipped with a lid 27 that allows the liquid 22 to flow through a nozzle 28 located at or near the center of the keg 26. The carbonation keg inlet lid 27 is attached to the carbon dioxide gas supply line 14, and the outlet is attached to a line 32 that feeds carbonated liquid into the storage keg 34. The supply keg 34 is equipped with a pressure safety valve (PSV) 18 that is set to open if the pressure in the keg exceeds 100 psi. Additionally, the storage keg 34 is equipped with a spunding valve 36 that releases displaced gas to the atmosphere as the keg is filled with liquid while holding the keg pressure constant.

Additional components of the system 10 of FIG. 1 include a carbon dioxide source 12, such as a cylinder filled with carbon dioxide. The supply 12 is connected to the liquid supply vessel 16 and the carbonation vessel 26 via a line 14 to provide carbon dioxide to the containers. A check valve 20 or other valve is shown in the line 14 to control the flow and/or direction of the flow of the gas in the system 10 as well.

In addition, the lines or conduits referenced can be any sufficient materials that would be acceptable for the stated purpose. This includes the gas lines for the carbon dioxide and the liquid conduits 24, 32. It should be noted that such lines are of the quality known and/or needed for the particular industry, such as being food or beverage grade. For example, the lines should be stainless steel or food grade hoses capable of transporting or holding gas and liquids at specified pressures.

At the start of operation, the carbonation and storage kegs 26, 34 are purged with carbon dioxide gas to ensure that the liquid 22 is only contacting carbon dioxide. The three kegs are then pressurized with carbon dioxide at levels appropriate to driving liquid through the lines 24, 32 of the system 10.

As an example, if the liquid 22 is to be carbonated to 15 psig, the storage keg 34 is pressurized to 15 psig, the carbonation keg 26 is pressurized to around 50 psig, and the supply keg 16 is pressurized to 80 psig with the goal of achieving a pressure differential across the nozzle 28 appropriate to atomizing the liquid 22 to droplets 30 fine enough to be rapidly carbonated. In this example, this pressure differential is around 30 psig although the actual value will depend upon the design and number of nozzles and the temperature of the liquid.

A flow control valve between the supply keg 16 and the carbonation keg 26 is opened to allow the still liquid 22 to spray into the atmosphere of carbon dioxide gas in the carbonation keg 26. The combination of droplet size, droplet residence time, pressure, and temperature in the carbonation keg 26 determines the carbonation level, measured as volume of carbon dioxide (standard conditions) dissolved in the gas per volume of liquid.

The carbonated liquid 31 pooling at the bottom of the carbonation keg 26 flows under pressure towards and into the storage tank 34, which may be a keg. When the process is complete, the supply keg 16 will have substantially emptied of still liquid 22 and the storage keg 34 will have filled with carbonated liquid 35 while the carbonation keg 26 essentially remains empty of liquid. It is important to note that in most circumstances the liquid leaving the carbonation keg 26 is not saturated with carbon dioxide as would be achieved under thermodynamic equilibrium at carbonation pressure. Instead, the goal is to achieve a carbonation level (volumes of gas per volume of liquid at standard temperature and pressure) that will be saturated with carbon dioxide when the pressure is reduced to that of the storage keg 34. In this way, the carbonated liquid 35 (e.g., beer) is not oversaturated in the storage vessel 34, which would produce foaming and waste carbon dioxide.

Due to the large pressure drop between the carbonation keg 26 and storage keg 34, there is potential for the carbon dioxide gas to nucleate into bubbles and come out of solution, reducing the final level of dissolved carbon dioxide below desirable levels, and producing undesirable foamed beverage in the storage keg 34. Therefore, the installation of a “pressure drop coil” 33 is helpful to the successful operation of this invention. The pressure drop coil 33 is in line with the carbonated conduit 32 and allows the high-pressure beverage in the carbonation keg 26 to gradually fall to the pressure of the storage keg 34 without nucleation of carbon dioxide bubbles. The length of tubing to achieve the desired pressure drop in the coil can be conservatively estimated as:

$$Tubing Length ( ft ) = \frac{Carbonation Keg Pressure ( psig ) - Storage keg Pressure ( psig )}{Tubing Resistance ( \frac{psi}{ft} )} \qquad ( 1 )$$

The tubing resistance is a function of the tubing material and internal diameter. Furthermore, the radius of the coil formed by the tubing adds to the resistance of liquid flow, which reduces the amount of tubing required below what is predicted by Equation 1.

In initial tests, the system 10, such as shown in FIG. 1, has carbonated beer in the batch system 10 to approximately 2.3 volumes of carbon dioxide at a rate of 1 gallon per minute without significant foaming. The carbonation level of many styles of beer is 2.1 to 2.6 volumes of carbon dioxide per volume of beer. Thus, the system 10 has been shown to be successful in reducing the amount of time for carbonation.

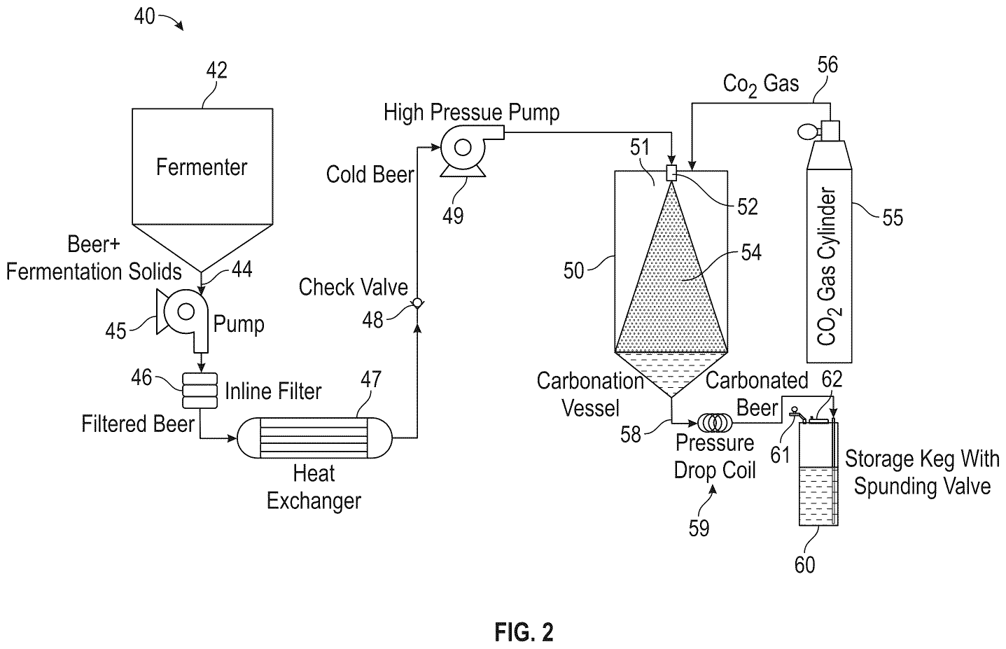

FIG. 2 illustrates another system 40 in the form of a continuous-flow system for carbonating beverages including beer, hard cider, kombucha, sparkling wine, and seltzer. According to the system 40 shown, the fermented but still (uncarbonated) beverage is pumped directly from the beverage production vessel (fermenter) 42 through a food grade pump 45 via a conduit 44 or other line. The beverage then flows through an inline filter 46 to remove suspended solids like yeast or protein, and then through a heat exchanger 47 to cool the beverage to the desired storage temperature. Although cooling the beverage is not necessary for rapid carbonation, it reduces operating pressure and the size of the carbonation vessel 50 required to achieve a desired volume of dissolved carbon dioxide per volume of beverage. A check valve 48 is positioned in the line 44 after the heat exchanger 47 to mitigate the liquid from flowing backwards through the system.

A second, high pressure pump 49 then brings the liquid to the pressure desired for expansion through the nozzle 52 at an inlet 51 in the carbonation vessel 50. According to some aspects of some embodiments, pumping and pressurizing the beverage would employ a single, high-pressure pump located after the filter 46 and heat exchanger 47 and before the carbonation vessel 50. In either pumping arrangement, beverage entering the carbonation vessel 50 passes through one or more nozzles 52 in the top of the carbonation vessel 50, which is continuously supplied with carbon dioxide gas at the desired carbonation pressure from a gas cylinder 55 connected to the carbonation vessel 50, such as via a CO2 line 56.

The falling droplets 54 from the atomized liquid passing through the one or more nozzles 52 absorb carbon dioxide, reaching a carbonation level that depends on the combination of droplet size, droplet residence time, and pressure and temperature in the carbonation vessel 50. In most circumstances, manipulation of the pressure in the carbonation vessel 50 is used to control the level of carbonation in the beverage exiting the carbonation vessel 50. The carbonated beverage pooled at the bottom of the carbonation vessel 50 flows under pressure via a line 58 through the pressure drop coil 59 into a storage keg 60 equipped with a spunding valve 61 in a lid 62, with the storage vessel 60 set at a storage pressure consistent with the desired volumes of carbonation. As with the batch carbonation system 10 previously described, in most circumstances the liquid leaving the carbonation vessel 50 is not saturated with carbon dioxide as would be achieved under thermodynamic equilibrium at carbonation pressure. Instead, the goal is to achieve a carbonation level (volumes of gas per volume of liquid) that will be saturated with carbon dioxide when the pressure is reduced to that of the storage keg 60.

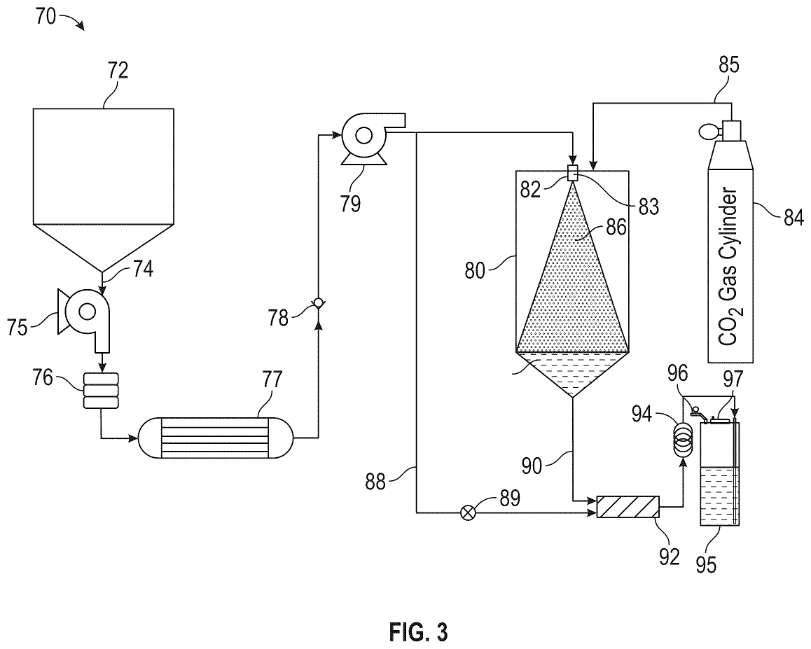

FIG. 3 shows another alternative manifestation of the continuous flow system 70. The system 70 shown in FIG. 3 includes many of the same components of the system 40 of FIG. 2. This includes a fermenter 72, which is the supply tank. A line 74 transports the liquid from the fermenter 72 through a high pressure pump 75, a filter 76, and then a heat exchanger 77 that will reduce the temperature of the liquid. The check valve 78 is also shown prior to the second pump 79. Again, a single pump may replace the two pumps in the manner described herein.

In addition, a carbon dioxide cylinder or tank 84 provides CO2 to the carbonation vessel 80 via a line 85.

According to the system 70 shown in FIG. 3, the cold beverage is split into two streams after the filtration, cooling, and pumping steps. For example, the figure shows a secondary conduit path 88 (still beverage line) after the second pump 79. As one example, one-fourth of the flow of beverage is directed to the carbonation system (including vessel 80 and one or more nozzles 83 at inlet 82, wherein the one or more nozzles 82 atomize the liquid into droplets 86 passing through the pressurized vessel 80) where it is carbonated to levels four times the desired final carbonation level of the beverage. This over carbonated beverage stream 90 is mixed with the remainder of (still) beverage using an in-line static mixer 92 to bring the final product to the desired volumes of carbon dioxide.

To ensure proper proportions of carbonated and still beer, a flow controller 89 is installed in the still beverage line 88. The mixed high-pressure stream is allowed to gradually return to storage pressure through a pressure drop coil 94, as previously described, before transferring it to a storage vessel 95 equipped with a spunding valve 96, such as in a lid 97. The arrangement of pumps, filter, and heat exchanger could be altered to achieve the desired temperature, clarity (from filtration, and volumes of gas of beer in the storage vessel. The actual stream splitting ratio and degree of carbonation could be altered depending on desired system characteristics.

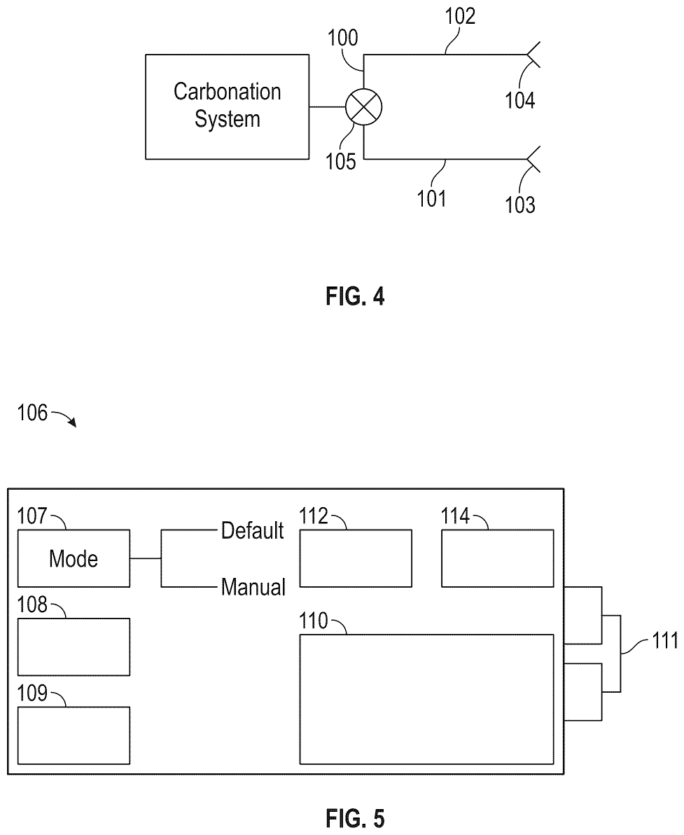

As an alternative to the single storage keg shown in the system diagrams, a manifold 100 could be employed to continuously fill kegs (see, e.g., FIG. 4). The manifold 100 is connected to any of the systems shown and/or described and is connected to a carbonation vessel to receive carbonated liquid therefrom. The manifold 100 can include a first line 101, second line 102, and generally any number of lines greater than 1, although two lines are shown in FIG. 4 for example purposes. One or more flow controls 105, such as valves, solenoids, or the like, divert the liquid to any of the lines or all of the lines at the same time. At the end of the lines are spouts for filling collection kegs, such as a first spout 103 and a second spout 104 shown in the figure.

As one keg is filled, such as at the first spout 103, the user would divert the flow of beverage to another keg via another line, such as the second line 102. The user would disconnect the filled keg and reattach an empty keg at the first spout 103. When the second keg is filled, the user repeats the process, starting to fill the third keg while switching in a fourth empty keg. The user would continue this process until all of the beverage has been carbonated and transferred to kegs. This system could also be semi-automated so that the flow of carbonated beverage is automatically diverted to the next empty storage vessel once one storage vessel is filled, and the user would switch out the filled vessel. Although the example described here includes two hookups for interchange of storage vessel, the actual number of storage vessel hookups could be increased as desired.

With respect to at least the brewing and carbonization of beer, but still important with other beverages, an important issue is whether the small droplets of beer with large surface area-to-volume ratios not only speed carbonation (good) but also speed loss of hop aroma and flavor compounds from the droplets (bad). Aspects of the present disclosure will indicate that sufficiently high carbonation pressures in the carbonation tank can keep these losses low. In fact, the process and/or systems disclosed herein does a better job of retaining aroma compounds during carbonation than does the traditional process of carbonating beer in brite tanks, in which the carbon dioxide bubbles rising through the beer can strip aroma compounds from it.

The necessary carbonation tank (gage) pressure, Pₜ, to prevent the fractional change in hop aroma compound concentration from falling by more than (C/Cₒ), (where C is final concentration and Cₒ is the starting concentration of hop aroma compounds) is given by:

$${P}_{t} = \frac{( {P}_{f} + 14.7 ) - ( {P}_{i} + 14.7 ) {( C / {C}_{o} )}^{∝}}{1 - {( C / {C}_{o} )}^{∝}} - 14.7$$

$$where$$

$$∝ = sqrt [ Diffusion coefficient hop oil / Diffusion coefficient carbon dioxide ] ∼ 0.94$$

It should be noted that, while a is shown to be ˜0.94, it should be appreciated that this could range from about 1 to about 0.75, based on the different diffusion coefficients of various hops compounds. P_{f} is the desired final beer carbonation gage pressure and Pᵢ is the initial carbonation pressure of beer, which is calculated from the volumes of residual CO₂ in the beer after fermentation, converted from absolute (partial) pressure to gage pressure to be consistent with other pressures used in the expression. Subtracting through by 14.7 simplifies to an expression that is completely in terms of gage pressure for all terms:

$${P}_{t} = \frac{{P}_{f} - {{P}_{i} ( C / {C}_{o} )}^{∝}}{1 - {( C / {C}_{o} )}^{∝}}$$

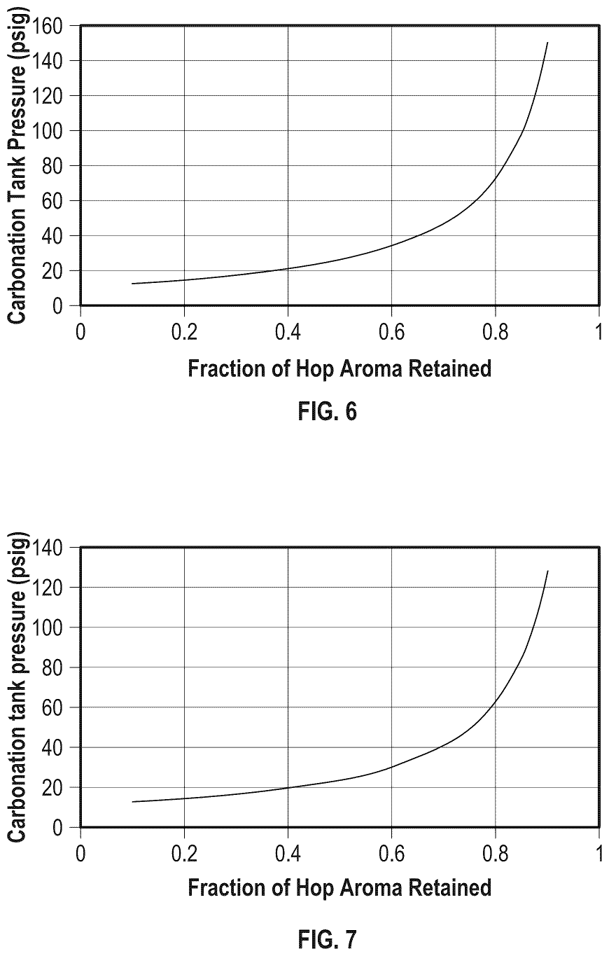

Note that residual carbonation in the liquid can dramatically reduce the carbonation tank pressure to achieve a desired carbonation level in the beer. For example, with no residual carbonation, the carbonation tank pressure to retain 80% of the volatile aroma and flavor compounds is 109 psig (assumes beer carbonated at 40 F). However, an ale fermented at 68 F has residual carbonation equal to 0.88 volumes of CO2 (per volume of beer) or pᵢ=−0.51 psig. FIG. 6 shows a graph of the carbonation tank pressure versus fraction of hop aroma retained for the ale as described herein. Furthermore, a lager fermented at 54 F has 1.12 volumes of residual CO2 or pᵢ=−2.5 psig. This drops Pₜ to 63 psig (beer at 40 F). FIG. 7 shows a graph of carbonation tank pressure versus fraction of hop aroma retained.

It should be appreciated that the results as shown in the figures are strongly dependent on Henry's constant for carbon dioxide as a function of temperature. The above were calculated from Henry's constant at 40 F. Lower temperatures increases Henry's constant, which lowers the carbonation tank pressure required to preserve hop oils in the carbonated beer.

Yet another element to any of the disclosed systems not indicated in the figures is an automated system 106 for carbonation control. This system 106 would operate in two modes, which can be set from a module 107. In the default mode, the user would select the style of beverage to be carbonated (IPA, wheat beer, sour beer, seltzer, sparkline wine, stout, etc.). The system 106 would use calibration data, such as from a database in memory 109, to automatically adjust the high-pressure pump settings, the heat exchanger settings, and the carbonation vessel pressure in order to achieve the level of carbonation appropriate to the selected beverage. In the manual settings mode, the user would have the option to select either the final desired carbonation level or the operating conditions (high-pressure pump settings, heat exchanger settings, and carbonation vessel pressure). In this way, the user has freedom to carbonate beverages using existing calibration data or experiment with different operational settings to achieve the desired product.

Additional components of the automation system include, but are not limited to, modules 107, such as the mode setting module, a processor and/or controller 108, a memory 109, a user interface 110, input/output ports 111, power 112, and a communication module 114. In some embodiments, a device could include one or more communications ports such as Ethernet, serial advanced technology attachment (“SATA”), universal serial bus (“USB”), or integrated drive electronics (“IDE”), for transferring, receiving, or storing data.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The system will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random-access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In at least one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

The power supply outputs a particular voltage to a device or component or components of a device. The power supply could be a DC power supply (e.g., a battery), an AC power supply, a linear regulator, etc. The power supply can be configured with a microcontroller to receive power from other grid-independent power sources, such as a generator or solar panel.

With respect to batteries, a dry cell battery [or a wet cell battery] may be used. Additionally, the battery may be rechargeable, such as a lead-acid battery, a low self-discharge nickel metal hydride battery (LSD-NIMH) battery, a nickel-cadmium battery (NiCd), a lithium-ion battery, or a lithium-ion polymer (LiPo) battery. Careful attention should be taken when using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

As noted, the automated system could be implemented on a user interface 110. The interface could also be a point on introduction of data, such as training data or test data to compare to the trained model for analysis. The results of the comparison could then be shown on a user interface.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

Any components of the system could be connected via network or other communication protocol to transfer information, communicate with other systems, or provide other connectivity. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Still additional components could include, but are not limited to, alarms (both visual and/or audial), sensors, timers, other alerts, or the like, which can provide additional information related to the operation of any of the systems.

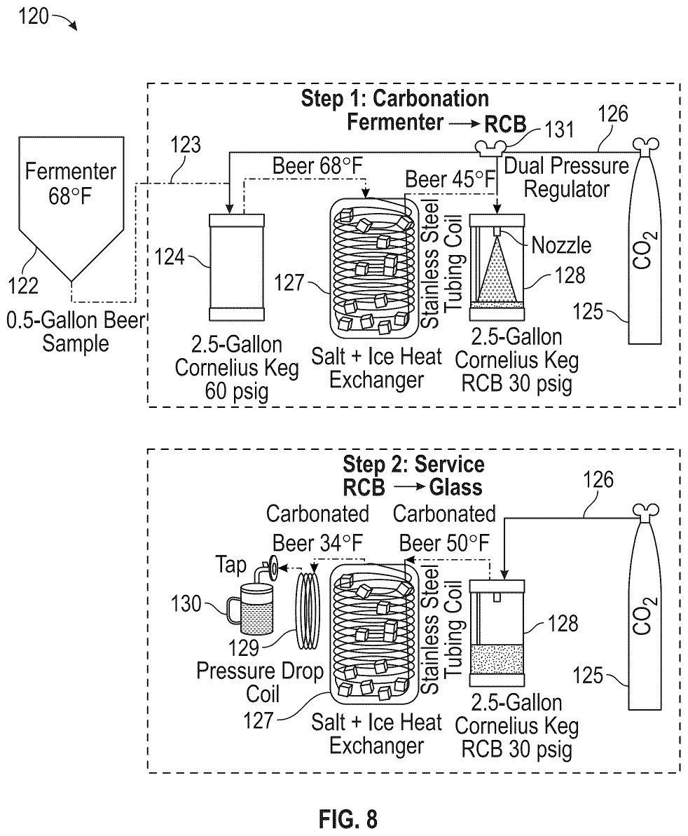

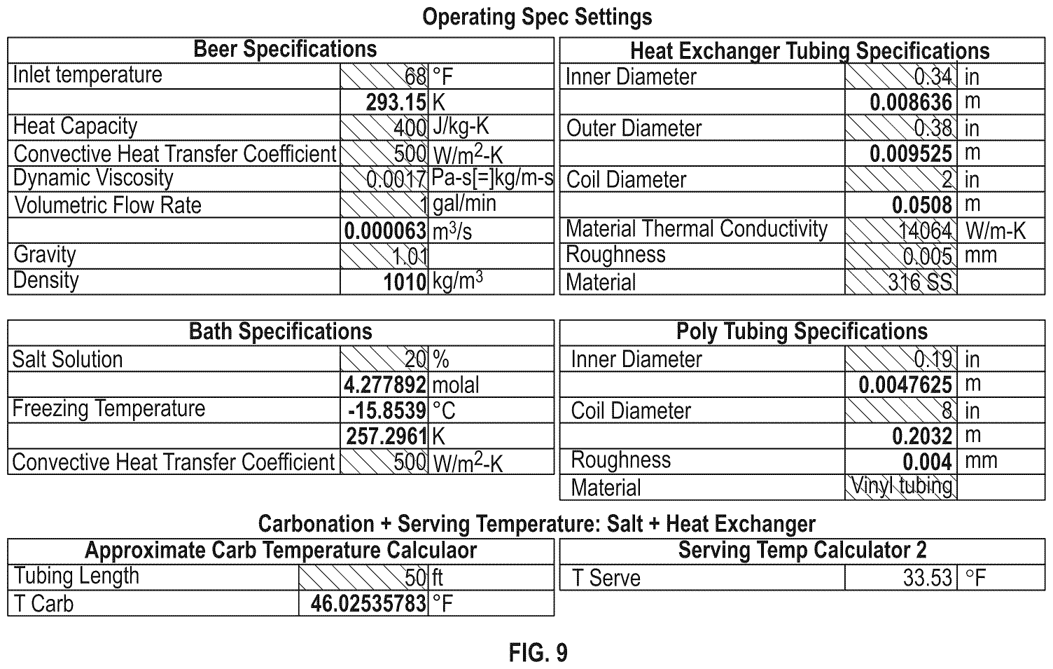

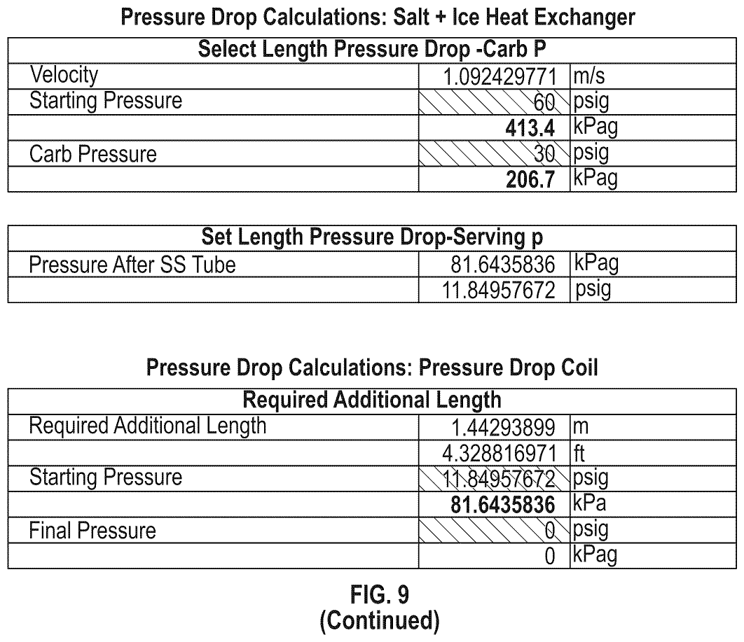

FIGS. 8 and 9 show yet additional systems and information utilizing concepts disclosed herein. While the systems and methods shown and/or described are generally for larger volumes of liquid, there are situations where it is beneficial to carbonate a smaller volume of liquid in a shortened time, such as to provide contemporaneous feedback on the product ahead of packaging. This can include, but is not limited to, providing flavor or aroma profiles. For example, many different inputs, such as different types and amounts of hops and/or other flavor profiles may be used in brewing different types of beer. Traditionally, the amounts and types are selected and added and the resulting liquid is carbonated, such as via the traditional brite tanks. If the flavor is not appropriate to the style, the liquid may be tossed or otherwise go unused.

To provide earlier feedback to operators (e.g., brewers), aspects of the carbonation system disclosed herein could be scaled to provide more immediate feedback. Referring to FIG. 8, a scaled system 120 is shown. The system 120 includes a fermenter 122, which is used to combine the components to make beer (e.g., water, grain, hops, yeast). Additional flavor inputs could be added to the fermenter as well, such as to test different flavor combinations. The fermenter 122 is smaller in size, such as to output a smaller amount of the beer. In the figure, 0.5-gallons is outputted by the fermenter 122 and passed through the line 123 towards a carbonation system, which is shown by the dashed lines. The beer is directed into a keg 124 or other container (such as a Cornelius keg), which may be pressurized with carbon dioxide from a tank 125 and line 126. The beer is then moved through a heat exchanger 127 to reduce the temperature. The heat exchanger 127 may use salt and ice, or other heat exchanging media, to reduce the temperature of the beer as it moves in a coil of the exchanger. The cooled beer (shown to be approximately 45 F is then moved into another container 128 for carbonation. The container 128 may be another Cornelius keg that includes a nozzle at the entry for atomizing the beer as it enters the container 128. The atomized beer is passed through carbon dioxide that has been supplied by the tank 125. This carbonizes the beer, which settles or collects in the container 125.

In the bottom portion of FIG. 8, step 2 of a process is shown. The carbonated beer that has collected in the tank 128 remains under carbon dioxide pressure. The path is reversed to move the beer from the container 128 and back through the heat exchanger 127, which will cool the carbonated beer even more. The figure shows the beer leaving the heat exchanger at approximately 34 F. This cooled beer is then passed through a pressure drop coil 129 to reduce the pressure, and then dispensed into a container via tap. The container may be a mug or another container. At this point, the low volume of beer can be smell and taste tested. The system shown allows for a relatively small volume of beer to be fermented and carbonated for taste testing in a short period of time (˜1-2 minutes). This near immediate feedback allows for changes to be made to the recipe for the beer and retested until a desired flavor and/or aroma profile results. Such a process will reduce the amount of waste and allow for quicker testing and refining of recipes to brewers in the beer making process.

FIG. 9 includes additional information related to the system 120, including some example settings and/or specifications for operating components of the system 120. For example, there is operational settings, heat exchange calculating and settings, as well as pressure drop coil calculations. While some numbers and/or settings have been provided, it should be appreciated that these are for example purposes, and are not to be seen as limiting or required.

Therefore, as has been shown, the systems, methods, and/or apparatus as shown and/or described provide numerous advantages and/or improvements for the carbonation of liquids, such as beverages. It should be appreciated that any of the aspects of any of the embodiments could be combined to create yet additional embodiments, even those not explicitly disclosed, but which are part of the present disclosure. Variations or alternatives to any of the embodiments that are obvious to those skilled in the art are also to be considered a part of the present disclosure.

1. A system for carbonating a liquid, comprising:
a liquid supply;
a carbonation vessel fluidly connected to the liquid supply to receive liquid therefrom, the carbonation vessel comprising a nozzle at an inlet, wherein the liquid passes through the nozzle to form droplets; and
a collection vessel fluidly connected to the carbonation vessel to receive the liquid from the carbonation vessel;
wherein the carbonation vessel is pressurized with carbon dioxide so the droplets pass through the carbon dioxide before collecting and moving to the collection vessel.

2. The system of claim 1, further comprising a pressure drop coil between the carbonation vessel and the collection vessel and wherein the carbonated liquid from the carbonation vessel is passed through the pressure drop coil.

3. The system of claim 1, further comprising a carbon dioxide source fluidly connected to carbonation vessel.

4. The system of claim 1, further comprising a pump to move the liquid from the liquid supply to the carbonation vessel.

5. The system of claim 1, further comprising a filter inline between the liquid supply and the carbonation vessel.

6. The system of claim 1, further comprising a heat exchange between the liquid supply and the carbonation vessel to cool the liquid before it is carbonated.

7. The system of claim 1, wherein the liquid is divided before the carbonation vessel with a first portion of liquid passed through the nozzle for carbonating in the carbonation vessel and the second portion bypasses the carbonation vessel, and wherein the first and second portions are combined in a mixer before passing into the collection vessel.

8. The system of claim 1, wherein carbon dioxide is added to the liquid supply to aid in moving the liquid towards the carbonation vessel.

9. The system of claim 1, wherein the collection vessel includes a spunding valve.

10. The system of claim 1, wherein the pressure of the carbonation vessel is selected based upon beverage type to retain a desired aroma profile.

11. The system of claim 10, wherein the desired aroma profile comprises a hop aroma.

12. The system of claim 1, wherein the liquid supply supplies 0.5-gallons of liquid to the system.

13. A method of carbonating a still liquid, comprising:
pressurizing a carbonation vessel with carbon dioxide;
adding still liquid into the carbonation vessel via a nozzle inlet, wherein the nozzle inlet breaks up the still liquid into small droplets that pass through the pressurized carbonation vessel;
collecting the carbonated droplets as a carbonated liquid; and
moving the carbonated liquid through a pressure drop coil and into a collection vessel.

14. The method of claim 13, further comprising pressurizing the collection vessel before the carbonated liquid is added thereto.

15. The method of claim 14, wherein the pressure of the carbonation vessel is selected based upon beverage type and residual carbonation and temperature of the liquid to retain a desired aroma profile.

16. The method of claim 15, wherein the desired aroma profile comprises a hop aroma.

17. The method of claim 13, further comprising filtering the still liquid before carbonation vessel.

18. The method of claim 17, further comprising cooling the still liquid after filtration.

19. The method of claim 13, further comprising splitting the still liquid into a first path that directs the liquid into the carbonation vessel via the nozzle inlet, and a second path that bypasses the carbonation vessel.

20. The method of claim 19, further comprising combining the liquids from the first and second paths before moving the carbonated liquid into the collection vessel.

21. The method of claim 20, further comprising mixing the liquids of the first and second paths via an inline static mixer.

22. The method of claim 13, wherein the still liquid is an amount 0.5-gallons or less.

23. The method of claim 22, further comprising cooling the carbonated liquid before moving the carbonated liquid through the pressure drop, and wherein the collection vessel is used for taste testing.

24. A system for carbonating a still liquid, comprising:
a liquid supply;
a carbonation vessel fluidly connected to the liquid supply to receive still liquid therefrom, the carbonation vessel comprising an atomizer at an inlet for the still liquid, wherein the carbonization vessel carbonates the atomized liquid; and
a collection vessel fluidly connected to the carbonation vessel to receive the carbonated liquid from the carbonation vessel.

25. The system of claim 24, wherein the carbonation vessel is pressurized with carbon dioxide so the atomized still liquid passes through the carbon dioxide before collecting and moving to the collection vessel.

26. The system of claim 24, further comprising a pressure drop coil between the carbonation vessel and the collection vessel and wherein the carbonated liquid from the carbonation vessel is passed through the pressure drop coil.

27. The system of claim 24, wherein the atomizer comprises a nozzle.
